(19) United States
(12) Patent Application Publication
(10) Pub. No.: US 2006/0028494 A1
(43) Pub. Date: Feb. 9, 2006

(54) Optical display driving method

(75) Inventors: Siebe Tjerk De Zwart, Eindhoven (NL); Volker Schoellmann, Eindhoven (NL); Peter Alexander Duine, Eindhoven (NL); Ruediger Johannes Lange, Eindhoven (NL); Oscar Hendrikus Willemsen, Eindhoven (NL); Roel Van Woudenberg, Eindhoven (NL); Jurgen Jean Louis Hoppenbrouwers, Eindhoven (NL); Johannes Marra, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/540,593

(22) PCT Filed: Dec. 5, 2003
(86) PCT No.: PCT/IB03/05820

§ 371 Date: Jun. 23, 2005

(30) Foreign Application Priority Data
Dec. 30, 2002 (EP) 020805438
Apr. 1, 2003 (EP) 031008618
Jun. 30, 2003 (EP) 031019466
Aug. 15, 2003 (EP) 031025497

(51) Int. Cl. G09G 5/10

(52) U.S. Cl. 345/691

(57) ABSTRACT

A display device comprising a plurality of pixels (26), a light source (23), and addressing means (24, 25) for coupling a selected pixel to said light source to thereby emit light, wherein the addressing means (24, 25) are arranged to address each pixel using pulse-width modulation (PWM). Further, the display comprises means (20) for amplitude modulating the intensity of said light source (23). The combination of the two modulations generates an exponentially distributed emitted light intensity, enabling proper gray scale rendering for a limited resolution in the time domain.

The present invention relates to a display device comprising a plurality of pixels, a light source, and addressing means for coupling a selected pixel to the light source to thereby emit light, wherein the addressing means are arranged to address each pixel using pulse-width modulation. The invention also relates to a driving method for such a display.

The principle of the above type of displays is that each pixel has two states (ON and OFF), and during the ON-state it is coupled to a light source to emit light. Such displays are here referred to as “optical” displays, and examples include foil displays and fiber displays.

The addressing is normally performed by first selecting a plurality of pixels, typically a line (row select), and then selecting one of the pixels on this line (column select). This addressing scheme is referred to as “line-at-a-time” addressing. An example of such displays is the line-at-a-time addressed foil display as described by V. Schollmann et al.

Alternatively, several lines, e.g. the entire display or a part of the display, are ON addressed in a sequential fashion during an addressing period. After such an addressing period, the display is illuminated during a display period, and pixels that were switched ON will emit light. Such addressing is known as address display separated (ADS) addressing.

In prior art optical displays, typically a constant-intensity lamp is used to feed light to a selected pixel, and pulse-width modulation on the column electrodes is used to determine the ON-time.

For a proper gray scale rendering with equally spaced gray levels, about 256 levels are needed. This number is primarily determined by requirements in the low gray-scale region. In a sub-field addressed display 256 gray levels can be displayed using 8 binary weighted sub-fields. To have equivalent gray scale rendering in the case of line-at-the-time addressing, the line time, typically in the order of Us, must be subdivided into 256 time slots, thus in the order of ns. Such short switching times are physically difficult to realize.

In the case of foil displays, for example, the switching time of the foil is about 2 μs. A minimum pulse-width of 2 μs results in a lowest gray scale in the order of 10% (or maybe 5%) of peak white.

Apart from the very lowest gray scale, the reaction time of the display addressing (e.g. rise time of the pulse) will also aggravate the accurate rendering of the other subsequent (low) gray scales. This is not acceptable for television or datagraphic applications.

It is an object of the present invention to provide an improved gray scale generation, thereby avoiding the need for impractically short switching times.

This object is achieved by a device of the kind mentioned in the introductory paragraph, further comprising means for amplitude-modulating the intensity of said light source.

The object is also achieved by a method for driving a display of the kind mentioned in the introductory paragraph, comprising pulse-width modulating said addressing means, and amplitude modulating the intensity of said light source.

According to the invention, light is fed to the pixels using a varying or graded intensity light source. In this way, the display is provided with entirely new means for gray level differentiation. The amplitude modulated light source defines the light intensity which is available for emission, while the PWM addressing regulates the ON-time and thus the gray level of the selected pixel. The combination of the two modulations can generate e.g. an exponentially distributed emitted light intensity, enabling proper gray scale rendering for a limited resolution in the time domain.

As already noticed, the need for 256 equally spaced gray scales primarily stems from requirements to properly display the lowest light levels. In the case of non-equally-spaced gray levels, much fewer levels are needed. With about 45 properly spaced gray levels a fully satisfactory image quality can be obtained.

Using pulse-width modulation in combination with a amplitude modulated light source, the gray levels can be adjusted as desired while the corresponding steps in the time domain (pulse-widths) remain constant.

The pulse-width modulation of the time period that the pixel emits light may be performed by switching the pixel on at the beginning of the line time, and regulating when the pixel is switched off, or switching the pixel off at the end of the line time and regulating when the pixel is switched on. Alternatively, it may be performed by regulating both when the pixel is switched on and when it is switched off. This will lead to more available gray levels with the same number of time slots.

Note that the term pulse-width modulation is intended to include also the ADS drive mentioned above, in which case the length of the pulse is decided by the period between consecutive addressing periods, and the light source is only illuminated during this period. In a special case, the pulses are of equal length, but are given different weights due to the different light intensity. The pulse-width modulation is then only a question of switching a pixel ON during a selected number of periods (pulses), and each pulse-width is either zero or the full corresponding display period.

According to one embodiment of the display according to the invention, a light guide directs light from the light source to all pixels, and the addressing means comprises a first and a second orthogonal set of electrodes, the pixels being defined by intersections of the electrodes. Light from the light guide is further coupled to a pixel by applying voltage pulses to the electrodes.

In other words, the addressing is completely separated from the modulated light source, which may be advantageous.

In this case, the first set of (non-pixel-selective) electrodes can be arranged to receive a constant select signal, and the second set of (pixel-selective electrodes) electrodes can be arranged to receive a pulse-width modulated select signal.

According to a second embodiment of the display according to the invention, the addressing means comprises a set of light guides, for directing light from the light source to each column (or rows) of pixels, and a set of electrodes, arranged to apply voltage to each row (or column) of pixels, thereby coupling said row to the light guides.

In this case, the light source is integrated in the addressing system by means of the light guides.

The display can comprise means for pulse-width modulating the light guides. In other words, pulse-width modulation is performed directly on the amplitude modulated light intensity, resulting in truncated amplitude curves.

The source intensity can be increased from a minimum value to a maximum value during a line period. The PWM addressing is then arranged to activate the selected pixel during a predetermined time starting from the beginning of the line period.

Alternatively, the source intensity starts at the maximum value and decreases to the minimum value. The PWM addressing is then accordingly shifted to the end of the line period.

The amplitude curve of the source intensity curve is not limited to a linear ramp. For instance, if it is required that the ratio between successive gray levels is constant, the source intensity should vary exponentially with time.

In the case of ADS addressing, the amplitude modulation consists of applying a different light intensity during each display period. As the pixel is switched ON or OFF during the entire display period, modulation of the intensity within a display period will not affect the displayed gray level of a pixel, and the intensity may thus be constant during a display period.

The amplitude curve of the source intensity can further be alternated between consecutive line periods, for example, the maximum value can be different. As a further example, the source intensity can increase during one line period and decrease during the next. This may be advantageous with regard to light source driving, enabling a continuous change of intensity (up and down), instead of discontinuous ramps.

The amplitude curve of the source intensity can further be alternated between different frames. By combining line alteration and frame alternation in a suitable way, line dithering can be achieved, generating additional gray levels.

These and other aspects of the invention will be apparent from the preferred embodiments more clearly described with reference to the appended drawings.

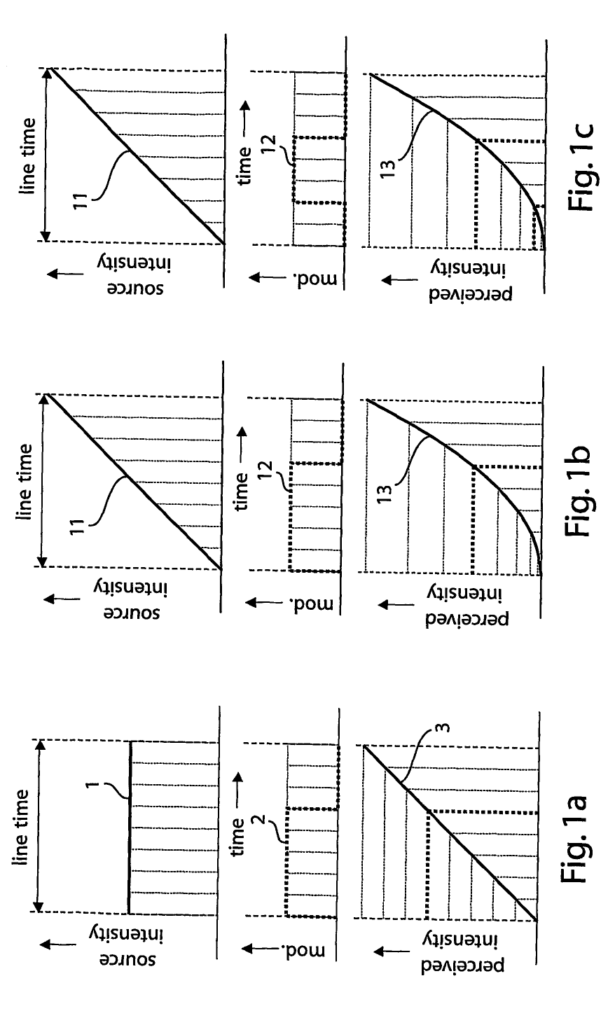

FIGS. 1a and 1b illustrates the principle of the invention compared to prior art.

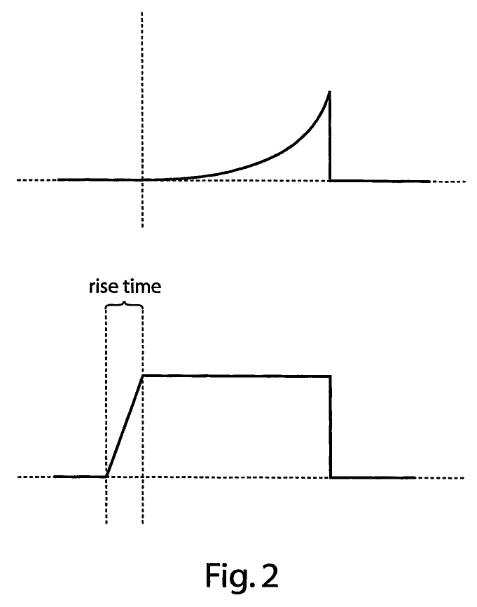

FIG. 2 illustrates delaying the light intensity modulation compared to the PWM pulse.

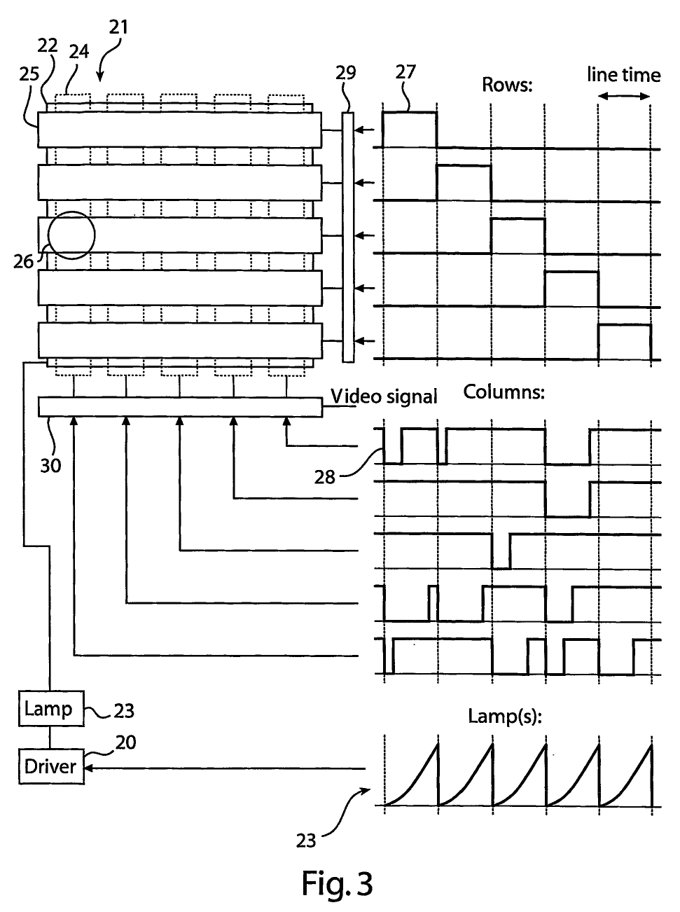

FIG. 3 illustrates the addressing scheme of a display according to a first embodiment of the invention.

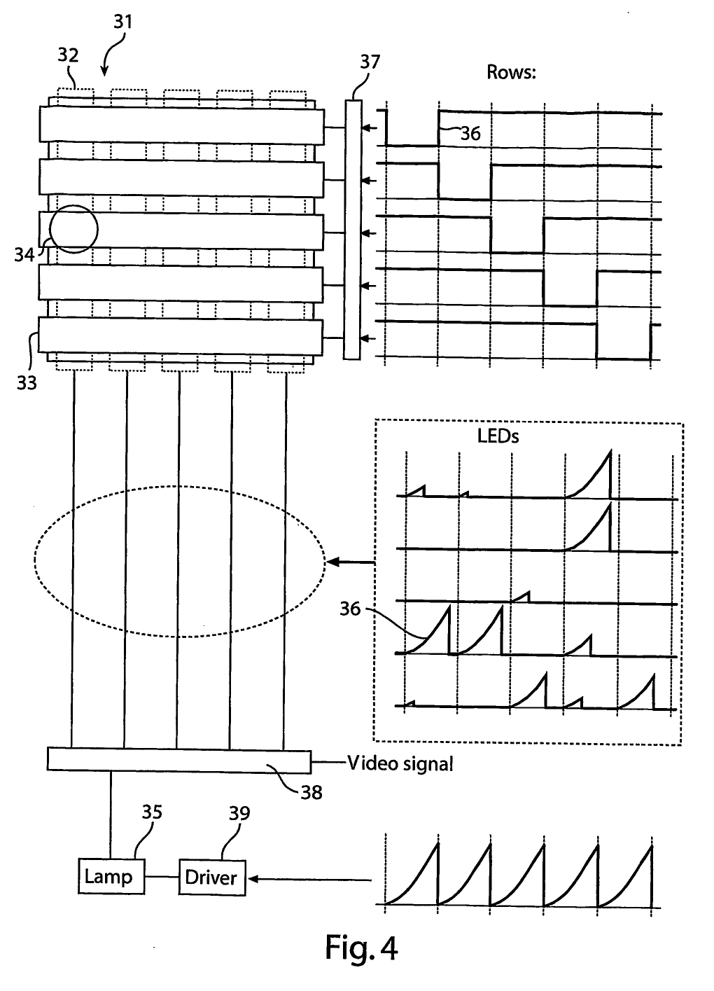

FIG. 4 illustrates the addressing scheme of a display according to a second embodiment of the invention.

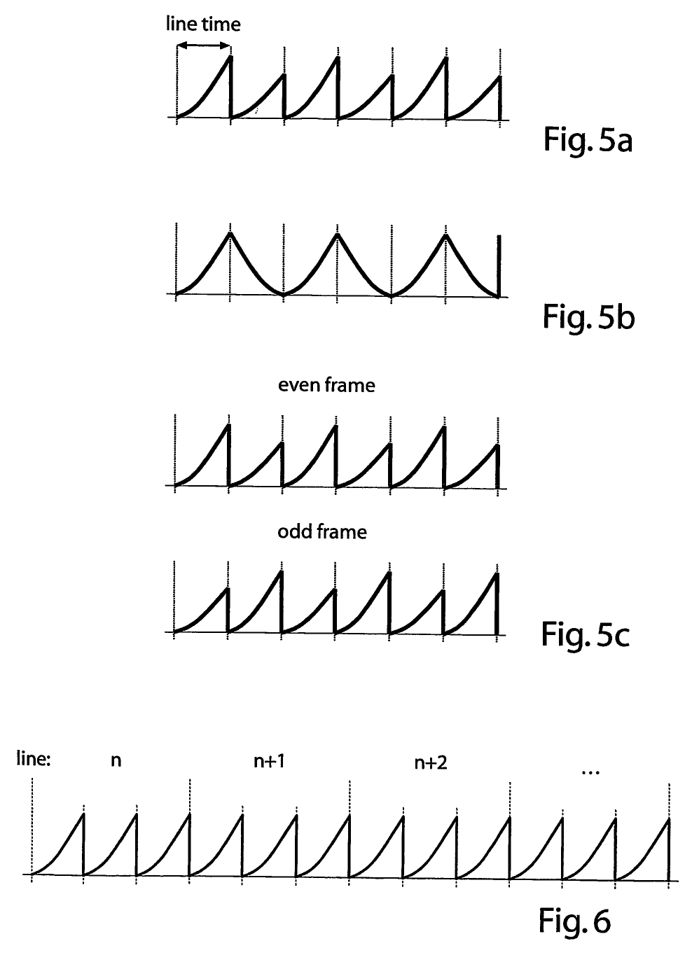

FIGS. 5a-5c show alternative amplitude curves of the source intensity.

FIG. 6 shows modulation of the source intensity in case of color sequential driving.

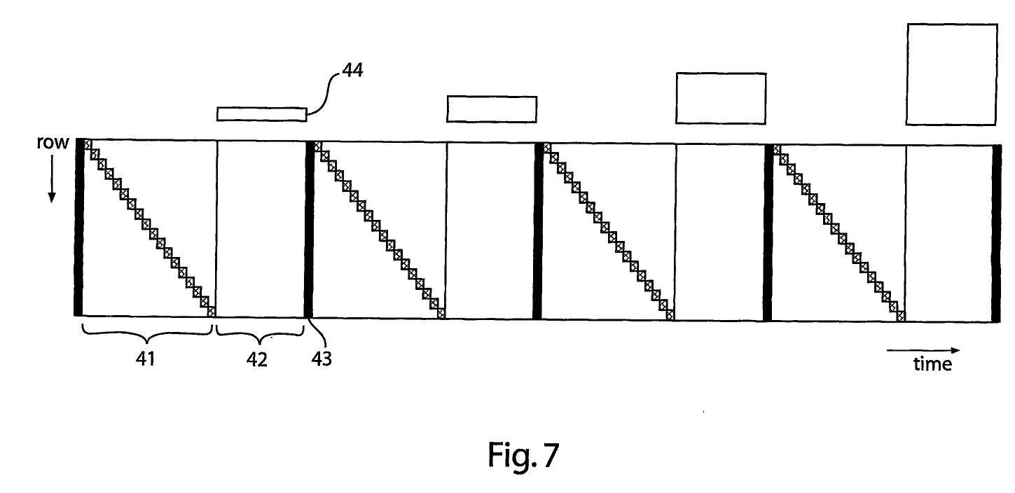

FIG. 7 shows a further embodiment of the invention, in the case of address display separated (ADS) drive.

In FIG. 1a, the drive of a conventional optical display is shown. The light source has a constant intensity 1 during the line time, and the length of the addressing pulse 2 determines the perceived intensity 3. As an example eight time-slots are indicated in the pulse 2, resulting in eight available gray levels. As the perceived intensity basically is the integral of the source intensity, the curve 3 is linearly increasing. As mentioned, the linear form of the perceived intensity 3 makes it difficult to achieve satisfactory gray level rendering, e.g. gamma correction.

In FIG. 1b, the light source is modulated according to the invention, in this case to have an intensity 11 increasing as a linear ramp during the line time. The addressing pulse 12 is applied as in FIG. 1a, and the pixel intensity 13 perceived by the viewer now varies with the squared modulation time (again the integral of the source intensity 11). As a result, the lower gray levels are much more closely spaced when compared to the constant intensity source case. Therefore, the low gray scales are relatively less sensitive to reaction time effects.

In the case of pulse-width modulation in combination with a linearly increasing intensity illustrated in FIG. 1b, the perceived output levels can be represented with weight factors of 1, 4, 9, 16, 25, 36, 49 and 64.

Instead of only varying the moment of switching off, as shown in FIG. 1b, it is also possible to vary the moment of switching on, see FIG. 1c. In this way, due to the varying light source intensity, the number of accessible gray levels is increased considerably.

For instance, and as is shown in FIG. 1c, it is possible to switch the pixel ON at the beginning of the third time slot and switch it OFF at the beginning of the sixth slot. Using the above-defined weights, the resulting perceived intensity will be represented by 25−4=21. Continuing in this way it, a table of accessible gray levels is obtained. This is shown in table 1.

TABLE 1
Gray-levels accessible by variably switching on and off

| | | | | | | | | | | | | | | | | |
|---|---|---|---|---|---|---|---|---|---|---|---|---|---|---|---|---|
| Gray level | 1 | 2 | 3 | 4 | 5 | 6 | 7 | 8 | 9 | 10 | 11 | 12 | 13 | 14 | 15 | 16 |
| weight | | | | | | | | | | | | | | | | |
| Accessible | x | | X | x | x | | X | X | x | | x | x | x | | x | x |
| Gray level | 17 | 18 | 19 | 20 | 21 | 22 | 23 | 24 | 25 | 26 | 27 | 28 | 29 | 30 | 31 | 32 |
| weight | | | | | | | | | | | | | | | | |
| Accessible | | | | x | x | | | X | x | | x | x | | | | x |
| Gray level | 33 | 34 | 35 | 36 | 37 | 38 | 39 | 40 | 41 | 42 | 43 | 44 | 45 | 46 | 47 | 48 |
| weight | | | | | | | | | | | | | | | | |
| Accessible | x | | X | x | | | X | X | | | | | x | | | x |
| Gray level | 49 | 50 | 51 | 52 | 53 | 54 | 55 | 56 | 57 | 58 | 59 | 60 | 61 | 62 | 63 | 64 |
| weight | | | | | | | | | | | | | | | | |
| Accessible | x | | | | | | X | | | | | x | | | x | x |

The table shows that the number of accessible gray levels is increased from 8 to 31 with the same-number of time slots.

In general it can be stated that the total number of accessible gray levels m for N available time slots is given by:

$$m = {\sum }_{i = 1}^{N} i \qquad ( Eq . 1 )$$

Note, however, that this number includes a number of duplicates, i.e. levels that can be obtained with different pairs of moments of switching on and off. For example, N=8 results in m=36 according to eq. 1, but only in 31 levels according to table 1, because five gray levels are duplicates (levels 9, 15, 16, 24 and 48).

While the advantage of selective switching on and off is an increase in the number of gray levels, it should be realized that this adds more complexity to the addressing of the pixels of the selected line, since it must be possible to switch any pixel of the line at any of the time slots on or off.

The effect of the rise-time of the pulse on the column electrode can further be eliminated by starting the pulse earlier than the intensity ramp, so that the peak pulse voltage has already been attained when the source is coupled to the pixel. This is illustrated in FIG. 2.

FIG. 3 shows a first embodiment of the invention. In this case, the display 21 comprises a light guide in the form of a plate 22, arranged to direct light from the source 23 to all pixels in the display. Further, the addressing is performed by two sets of orthogonal electrodes 24, 25, the pixels being defined by intersections 26 between electrodes. The electrodes are controlled by a column driver 29 and a row driver 30. The line-at-a-time foil display will in the following be used as an example of such a display.

For simplicity it is assumed that the foil is at ground potential (0V). A row is selected by applying a voltage pulse 27 (e.g. 20V) to that particular row. Pixels can be switched on or off by applying a suitable voltage 28 to the columns, e.g. 0V (on) or 20V (off). It is essential that the pixels can be either in the on- or in the off-state. In the case of 480 rows and a frame frequency of 100 Hz the row selection time (line time or line period) is approximately 20 μs.

According to the invention, the light source 23 is controlled by a lamp driver 20, adapted to modulate the source intensity according to a predefined curve.

As a light source 23, a plurality of LED lamps can be used. By adapting the driver 20 to light different numbers of LEDs, a varying source intensity may be achieved. LEDs can be switched fast enough for this purpose, but they are still relatively expensive. In principle, fluorescent lamps could do the job, provided that they are equipped with sufficiently fast phosphors.

A second embodiment of the invention is shown in FIG. 4, showing a display 31 where a set of light guides 32 take an active part in the addressing. The display further comprises a set of electrodes 33, arranged orthogonally to the light guides 32 and controlled by a row driver 37. The pixels 34 are defined by the intersections between light guides 32 and electrodes 33. Each light guide 32 is arranged to direct light from a source 35 to a column (or row) of pixels 34. The light guides 32 are further individually pulse-width modulated by a column driver 38, in order to enable gray level rendering. When a row (or column) is selected by a voltage pulse 36 on the corresponding electrode 33, any light in the light guides is coupled to this row, and emitted.

An example of such a display is the fiber-optic display, where the column light guides 32 consist of optical fibers.

According to the invention, each light source 35 is further arranged to be amplitude-modulated by a lamp driver 39. As mentioned above, this can be achieved by using a plurality of LEDs for each light source 35.

The result is a set of truncated light pulses 36, formed by a combination of amplitude modulation and PWM, which light pulses 36 are directed to the columns of the display, and emitted at the selected row.

In the description above, the source intensity has been assumed to have the same amplitude curve (increasing ramp) for all line times. However, this is not a prerequisite. Consecutive line times can have different amplitude curves, if this is deemed advantageous. For example, the maximum value of the signal may be different (FIG. 5a) or the slope of the amplitude curve can be alternating (FIG. 5b). In the case of a decreasing amplitude during the line time, the pulse-width modulation should regulate when the pixel is switched on, and the pixel can be switched off at the end of the line time.

Also, the source intensity may be different for consecutive frames, if this is deemed advantageous. Such frame alteration can combined with the line time alterations, as illustrated in FIG. 5c. Such amplitude modulation can enable line dithering, with additional gray levels as a result.

In case of color sequential driving, each line is divided into three segments, one for each color, and the source intensity modulation can be of the form illustrated in FIG. 6. In this case, it is not necessary for each segment to have identical source intensity modulation, or, for that matter, time periods.

FIG. 7 is an example of the invention implemented in an address display separated (ADS) addressing scheme, here including 18 rows. All rows are addressed during an addressing period 41 by consecutively selecting one row at a time and switching the desired pixels ON. After this ON-scan, the light source is activated during a display period 42, and all pixels that were switched ON during the addressing period will emit light. Then, during a third period 43, all pixels are turned OFF. In the illustrated case, this OFF action is performed for all pixels simultaneously. According to the invention, light of different intensity is applied to different display periods, thereby enabling a weighting of the display periods. In the illustrated example, all display periods are of equal length, while the light intensity is alternated between different binary levels 44 (1, 2, 4, 8 etc). The selection of suitable display periods here represents the pulse-width modulation, while the different amplitudes represent the amplitude modulation.

Further modifications of the presented embodiments will be possible for a man of skill in the art, without departing from the inventive concept defined by the claims. In particular, different means may be suitable for providing the pulse-width modulated addressing, depending on the specific application.

1. A display device comprising
a plurality of pixels (26; 34),
a light source (23; 35), and
addressing means (24, 25; 32, 3,3) for coupling a selected pixel to said light source to thereby emit light,
said addressing means (24, 25; 32, 33) being arranged to address each pixel using pulse-width modulation (PWM), characterized by
means (20; 39) for amplitude modulating the intensity of said light source (23; 35).

2. A display device according to claim 1, wherein said addressing means (24, 25; 32, 33) are adapted to regulate when each pixel is switched on and/or when each pixel is switched off during a line time.

3. A display device according to claim 1, wherein a light guide (22) directs light from the light source (23) to all pixels (26), and wherein said addressing means comprises a first and a second orthogonal set of electrodes (24, 25), said pixels (26) being defined by intersections of said electrodes, and wherein light from the light guide is coupled to a pixel by applying voltage pulses (27, 28) to the electrodes.

4. A display device according to claim 3, wherein said first set (25) is arranged to receive a constant select signal, and said second set (24) is arranged to receive a pulse-width modulated select signal.

5. A display device according to claim 1, wherein said addressing means comprises a set of light guides (32), each for directing light from the light source (35) to one column of pixels (34), and a set of electrodes (33), each arranged to apply voltage to one row of pixels (34), thereby coupling said row to the light guides (32).

6. A display device according to claim 5, further comprising means (39) for pulse-width modulating said light guides (32).

7. A method for driving a display device having a plurality of pixels (26; 34), a light source (23; 35), and addressing means (24, 25; 32, 33) for coupling a selected pixel to said light source to thereby emit light, comprising:
pulse-width modulating said addressing means, characterized in
amplitude modulating the intensity of said light source.

8. A method according to claim 7, wherein said source intensity is increased from a threshold value to a maximum value during a line period (FIG. 5a).

9. A method according to claim 7, wherein the amplitude curve of said source intensity is alternated between consecutive line periods (FIG. 5b).

10. A method according to claim 9, wherein said source intensity is increased from a threshold value to a maximum value during one line period and decreased from said maximum value to said threshold value during the next consecutive line period FIG. 5b).

11. A method according to claim, wherein the amplitude curve of said source intensity is alternated between consecutive frames (FIG. 5c).

12. A method according to claim, wherein said pulse-width modulating includes regulating when each pixel is switched on and/or when each pixel is switched off during a line time.
